(19) United States
(12) Patent Application Publication
(10) Pub. No.: US 2025/0341702 A1
(43) Pub. Date: Nov. 6, 2025

(54) ROLLED FIBER RIBBON AND METHOD FOR MANUFACTURING

(71) Applicant: CommScope Technologies LLC, Hickory, NC (US)

(72) Inventors: Benjamin D. STEWART, Hickory, NC (US); David Allyn WIEBELHAUS, Hickory, NC (US)

(73) Assignee: CommScope Technologies LLC, Hickory, NC (US)

(21) Appl. No.: 18/855,517

(22) PCT Filed: Apr. 21, 2023
(86) PCT No.: PCT/US2023/019447

§ 371 Date: Oct. 9, 2024

Related U.S. Application Data
(60) Provisional application No. 63/333,341, filed on Apr. 21, 2022.

(51) Int. Cl. G02B 6/44

(52) U.S. Cl. CPC G02B 6/448

(57) ABSTRACT

An optical fiber ribbon includes optical fibers bonded together at intermittent points at both the first major side and the second major side of the ribbon. The bonding points at the second major side of the ribbon do not align along the thickness of the ribbon with the bonding points at the first major side of the ribbon. In some examples, the bonding points are offset along the length of the ribbon. In other examples, the bonding points are offset along the width of the ribbon. The bonding points at the first and second side can be applied at the same bonding material application station or at a different bonding material application station.

### CROSS-REFERENCE TO RELATED APPLICATION

This application is being filed on Apr. 21, 2023, as a PCT International application and claims the benefit of and priority to U.S. Provisional Application No. 63/333,341, filed Apr. 21, 2022, the disclosure of which is hereby incorporated by reference in its entirety.

### BACKGROUND

A traditional optical fiber ribbon includes a plurality of optical fibers secured together by a relatively rigid matrix material. The matrix material prevents relative movement between the optical fibers of the fiber ribbon and retains the optical fibers in a row. In particular, the matrix material retains the optical fiber in a linear array such that at any given location along the length of the fiber ribbon the optical fibers are retained in a planar arrangement by the matrix materials. The matrix material protects the optical fibers, allows the optical fibers to be handled as a group and maintains the optical fibers in a predetermined sequence. However, the matrix material also provides the fiber ribbon with a preferred bend orientation and the planar configuration has driven cable designs and fiber management systems having fiber densities that are lower than what is sometimes desired in the marketplace. The optical fibers of a traditional fiber ribbon can be separated from each other (e.g., by stripping off the matrix material) to prepare the optical fibers for splicing or termination.

In recent years, so called “rollable” optical fiber ribbon has increased in commercial acceptance and popularity. In a rollable optical fiber ribbon, the optical fibers are interconnected by bonding material such that the optical fibers are maintained in a predetermined sequence and can be handled together as a group. However, in contrast to a traditional optical fiber ribbon, the optical fibers of a rollable fiber ribbon can be moved relative to one another to a rolled, bunched, or other type of non-planar configuration. The mechanical attributes of rollable optical fiber ribbon have opened the possibility for cable configurations and fiber management systems having higher fiber densities than was possible with traditional optical fiber ribbon. Rollable optical fiber ribbons have been developed with different designs. For example, rollable optical fiber ribbon designs can include intermittent connection points between the optical fibers (e.g., staggered or non-staggered connection points), a sheet of flexible matrix material connecting the optical fibers, a continuous layer of slitted matrix material connecting the optical fibers, beads of matrix material connecting the optical fibers, or other ribbon designs. Example documents disclosing example rollable optical fiber ribbons include: U.S. Pat. Nos. 5,682,454; 10,185,105; 9,880,368; 10,488,609; 10,488,609; 10,007,078; 9,995,896; 9,086,555; and U.S. Patent Application Publication No. 2020/0271879.

### SUMMARY

Certain aspects of the disclosure are directed to a fiber ribbon configured to be flexed into a non-planar configuration. In certain implementations, the optical fibers of the fiber ribbon are bonded together at intermittent points at both the first major side and the second major side of the ribbon.

In certain implementations, the bonding points at the second major side of the ribbon are offset from the bonding points at the first major side of the ribbon. In some examples, the bonding points are offset along the length of the ribbon. In other examples, the bonding points are offset along the width of the ribbon.

In accordance with certain aspects of the disclosure, the fiber ribbon is manufactured in a planar configuration by intermittently applying bonding material in discrete volumes in a first pattern along a first major side of the ribbon and in a second pattern along a second major side of the ribbon. The discrete volumes of the second pattern do not align with the discrete volumes of the first pattern along a thickness of the ribbon. In some examples, the second pattern is different from the first pattern. In other examples, the second pattern is the same as the first pattern, but is offset along the length or width of the ribbon.

In some implementations, the bonding material is dispensed onto the fibers at a first major surface of the row at a first application station and is dispensed onto the fibers at a second major surface of the row at a second application station. In other implementations, the bonding material is dispensed onto both major surfaces of the row of fibers at a common application station.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a top plan view of an example fiber ribbon including a plurality of optical fibers arranged in a planar orientation and bonded together at first intermittent points at a first side of the ribbon and at second intermittent points at an opposite, second side of the ribbon;

FIG. 2 is an end view of an optical fiber ribbon of FIG. 1;

FIG. 3 is a schematic diagram showing the fiber ribbon of FIG. 2 curled into a rolled configuration;

FIG. 4 is a schematic diagram showing an example manufacturing line at which the optical fiber ribbon of FIGS. 1-3 can be formed;

FIG. 5 is a schematic diagram showing one example implementation of an application station suitable for use in the manufacturing line of FIG. 4;

FIG. 6 is a schematic diagram showing another example implementation of an application station suitable for use in the manufacturing line of FIG. 4;

FIG. 7 is a schematic diagram showing an example implementation of a second application station suitable for use in the manufacturing line of FIG. 4;

FIG. 8 shows the optical fiber ribbon of FIG. 1 twisted or stranded along a lay length; and

FIG. 9 is a transverse cross-sectional view of an example cable including one or more of the fiber ribbons; the fiber ribbons of FIG. 9 shown curled into rolled configurations.

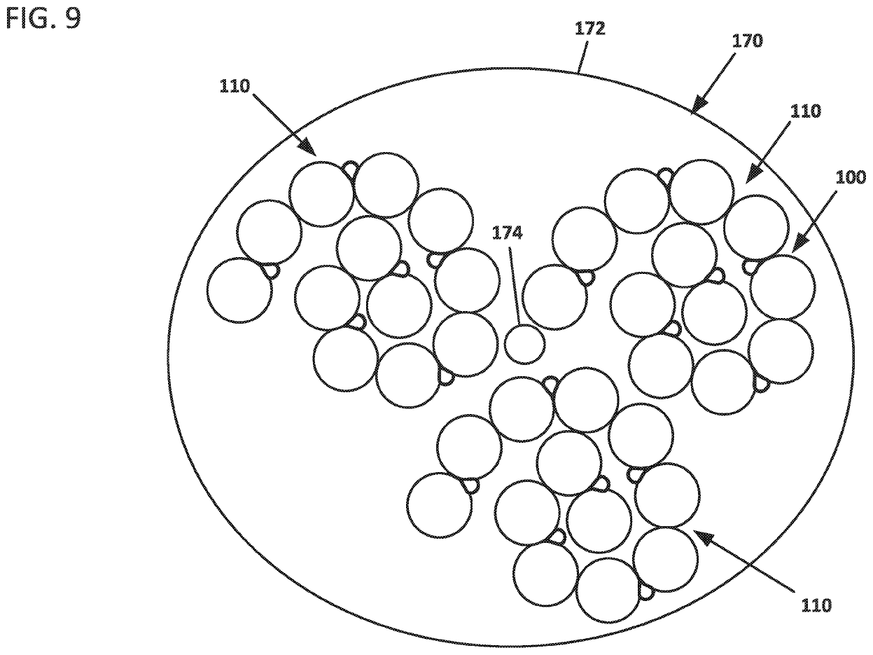

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

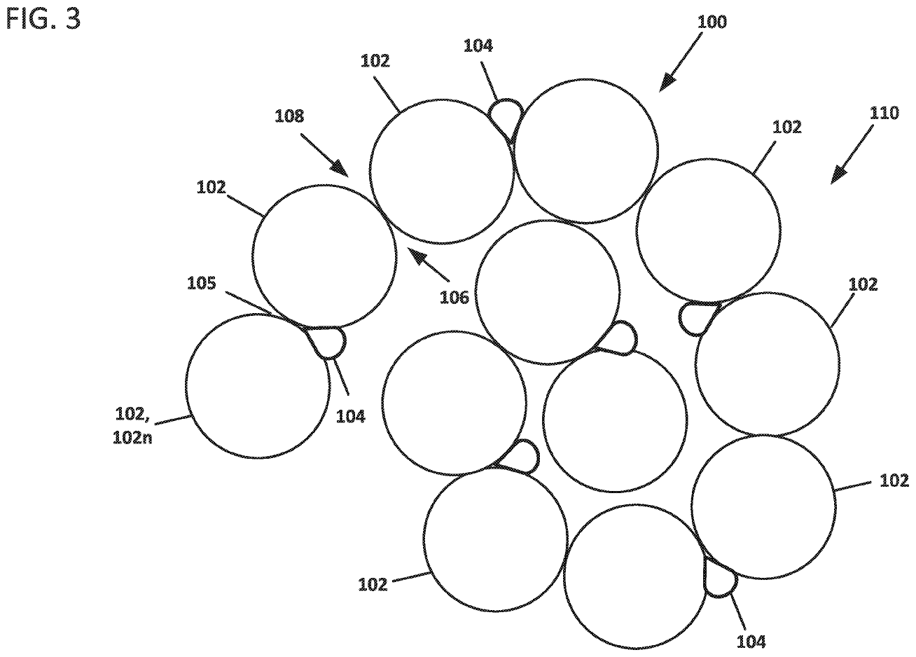

The present disclosure is directed to an optical fiber ribbon 100 configured to be transitioned to a rolled configuration and a processes for manufacturing the optical fiber ribbon 100. When in the rolled configuration, the fiber ribbon 100 may have a spiral-shaped transverse cross-sectional profile (e.g., see FIG. 3). The fiber ribbon 100 may be unrolled into a planar configuration for splicing (e.g., mass fusion splicing) or connectorization (i.e., terminating the optical fibers at one or more optical connectors).

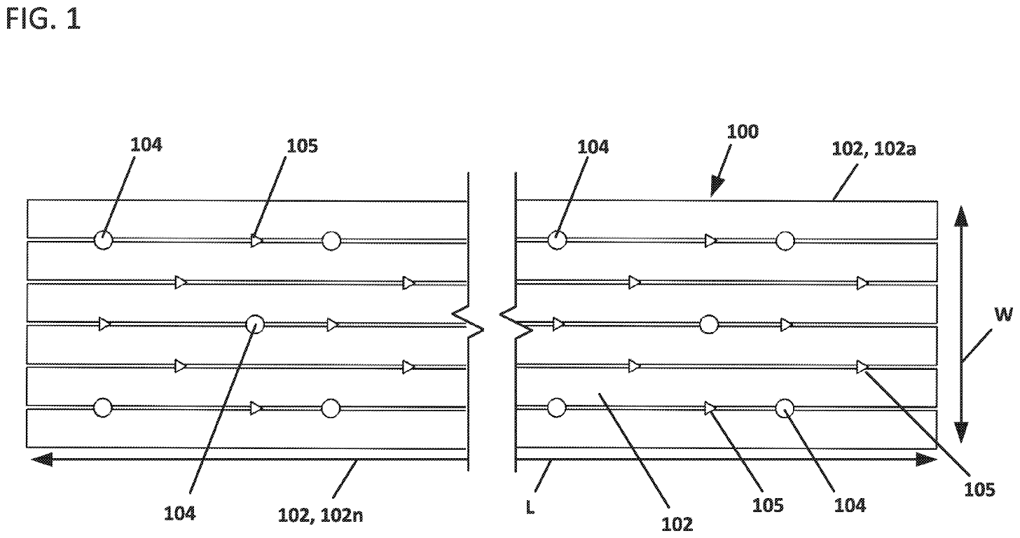

Referring to FIGS. 1-3, two or more optical fibers 102 can be bonded together in a sequence (e.g., a consecutive order) from a first fiber 102a to a last fiber 102n to form an optical fiber ribbon 100. The ribbon 100 has a length L, a thickness T and a width W. The ribbon 100 has a first major side 106 and an opposite second major side 108 that each extend along the length L and the width W. The first and second major sides 106, 108 of the optical fiber ribbon 100 are separated by the thickness T and the optical fibers are consecutively ordered along the width W. In certain examples, the first fiber 102a forms a first edge of the ribbon 100 and the last fiber 102n forms an opposite second edge of the ribbon 100. The first and second edges are separated by the width W of the optical fiber ribbon 100.

In the example shown, twelve optical fibers 102 are bonded together to form the fiber ribbon 100. In other implementations, the fiber ribbon 100 may include a greater or lesser number (e.g., four, six, eight, ten, sixteen, twenty-four, thirty-six, etc.) of fibers 102. The fiber ribbon 100 maintains the optical fibers 102 in the sequence so that specific ones of the optical fibers 102 can be identified at both axial ends of the fiber ribbon 100. In certain examples, the optical fibers 102 each include a core, a cladding layer surrounding the core, and a coating layer surrounding the cladding layer. In one example, the coating layers each have an outer diameter in the range of 240-260 microns and the optical fibers of the ribbon have a center-to-center spacing in the range of 240-260 microns. In other examples, the coating layers each have an outer diameter in the range of 190-210 microns and the optical fibers of the ribbon have a center-to-center spacing in the range of 190-210 microns

The optical fibers 102 are bonded together using bonding material 104. In certain examples, the bonding material 104 includes a curable material that is cured via time or the application of energy (e.g., radiant energy such as heat or light (e.g., ultraviolet radiation)). In certain examples, the bonding material 104 is chemically curable by application of water or another chemical. In certain examples, the bonding material 104 is an adhesive such as an epoxy. In certain examples the bonding material 104 can include a thermoplastic material or a thermoset material.

In some implementations, the bonding material 104 is applied to the optical fibers 102 in discrete volumes (e.g., beads, dots, etc.) at intermittent locations along the contiguous edges of the optical fibers 102. In certain implementations, the discrete volumes of bonding material 104 are applied to the optical fibers 102 at the opposite major sides 106, 108 of the row. In certain implementations, the discrete volumes of bonding material 104 applied to the second major surface of the row of optical fibers 102 are axially offset along the length L of the ribbon 100 from the discrete volumes of bonding material 104 applied to the first major surface. In certain implementations, the discrete volumes of bonding material 104 applied to the second major surface of the row of optical fibers 102 are laterally offset along the length W of the ribbon 100 from the discrete volumes of bonding material 104 applied to the first major surface.

In FIG. 1, the discrete volumes of bonding material 104 applied to the first surface 106 of the ribbon 100 are shown as circles. The discrete volumes of bonding material 104 applied to the second surface 108 of the ribbon 100 are indicated by triangles superimposed over the first surface 106 for ease in viewing. It will be understood that at each triangle in FIG. 1, a discrete volume of bonding material 104 is disposed on the side of the optical fibers 102 that is not visible in FIG. 1.

In certain implementations, the discrete volumes of bonding material 104 are disposed in geometric patterns along the length of the ribbon 100. In the example shown, the discrete volumes of bonding material 104 are disposed in V-shaped patterns. In other examples, the discrete volumes of bonding material 104 can be disposed in W-shaped patterns, diagonal line patterns, or other patterns. In some implementations, the bonding material 104 at the first and second sides 106, 108 of the ribbon 100 is applied in a common, repeated pattern (i.e., the patterns are mirrored), but the pattern at the second side 108 is offset (e.g., axially offset and/or laterally offset) from the pattern at the first side 106. In other implementations, the bonding material 104 is applied to the first side 106 of the ribbon 100 in a first pattern and applied to the second side 108 of the ribbon 100 in a different, second pattern.

In some implementations, each adjacent pair of optical fibers 102 is bonded at only the first side 106 or the second side 108 of the ribbon 100 along the length L of the ribbon 100. For example, bonding material 104 may be applied between the first and second fibers 102a, 102b at the second side 108 of the ribbon 100 while bonding material 104 is applied between the second and third optical fibers 102b, 102c at only the first side 106 of the ribbon. In other implementations, each adjacent pair of optical fibers 102 is bonded at both the first and second sides 106, 108 at spaced locations along the length of the fibers 102.

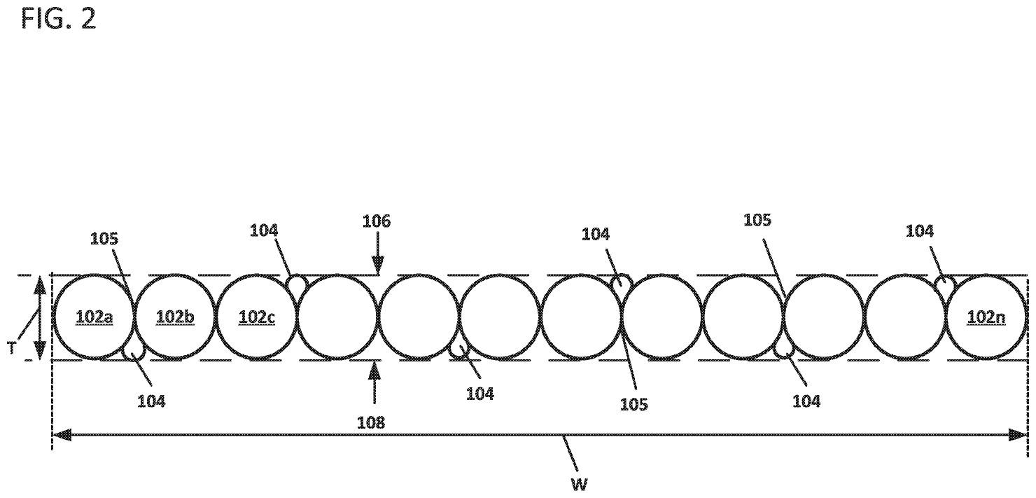

As shown in FIG. 2, not all fibers 102 are bonded together along the same transverse cross-sectional plane. In certain examples, fibers 102 of the ribbon 100 are bonded only on one side 106, 108 within a transverse cross-sectional plane. In certain examples, fibers 102 are bonded on both sides 106, 108 of the ribbon 100 in offset pairs within a transverse cross-sectional plane. In other implementations, fewer than all pairs of fibers are bonded together in a common transverse cross-sectional plane. For example, the bonding material 104 may be distributed so that only one pair of optical fibers 102 is bonded together per transverse cross-sectional plane. In another examples, only one pair of optical fibers 102 per side 106, 108 are bonded together per transverse cross-sectional plane.

In accordance with certain aspects of the disclosure, the offset (e.g., axial offset and/or lateral offset) of the bonding material 104 between the opposite sides 106, 108 of the fiber ribbon 100 facilitates flexing of the fiber ribbon 100 along the width W. For example, because the first and second optical fibers 102a, 102b are connected at only the second side 108 of the ribbon 100, the ribbon 100 can be easily flexed to constrict the second side 108 and elongate the first side 106. Further, the next discrete volume of bonding material 104 at the second side 108 shown in FIG. 2 is displaced from the first discrete volume of bonding material 104 by a number of fibers 102. The lack of bonding material 104 along the width of the fiber ribbon 100 that would otherwise interfere with the bending of the ribbon 100. However, because the first side 106 also has intermittent discrete volumes of bonding material 104, the same principles apply.

In certain implementations, adjacent ones of the optical fibers 102 can be flexed away from each other at certain points along the length L of the ribbon 100. For example, in FIG. 2, the second and third optical fibers 102b, 102c from the first edge of the ribbon 100 can be flexed away from each other at the displayed position along the length L while the first and second optical fibers 102a, 102b cannot be as they are connected together using a discrete volume of bonding material 104 at the displayed position along the length L.

FIG. 3 shows the fiber ribbon 100 transitioned into a rolled configuration 110. In the example shown, the fiber ribbon 100 is rolled into a spiral configuration. In other examples, however, the fiber ribbon 100 may be rolled into a cylindrical configuration. In still other examples, the fiber ribbon 100 can be flexed or folded into an S-shaped configuration or other shape having an inconsistent bend. In the example shown in FIG. 3, an outer side of the spiral 110 is formed by the second side 108 of the ribbon 100 and the inner side of the spiral 110 is formed by the first side 106. In examples, however, the first side 106 may form the outer side of the spiral 110 while the second side 108 forms the inner side because a common amount of bonding material 104 is disposed on each side 106, 108, the fiber ribbon 100. In other implementations, different amounts of bonding material 104 can be applied to each side 106, 108 to provide a preferential bend to the fiber ribbon 100.

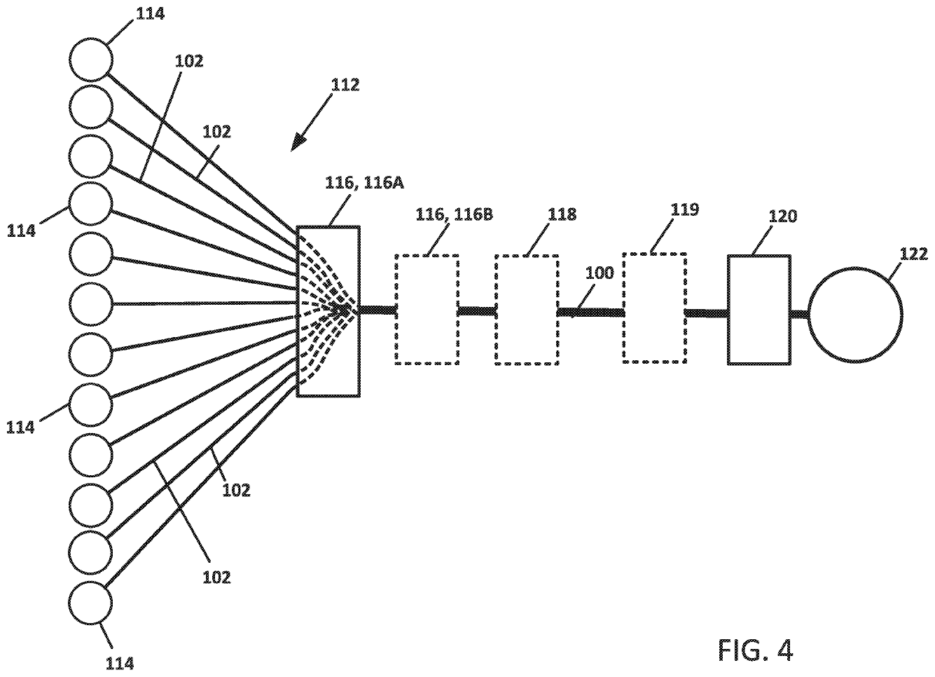

Referring to FIG. 4, a manufacturing line 112 for forming a fiber ribbon 100 is shown. The manufacturing line 112 includes a plurality of payoff reels 114, at least one bonding material application station 116 (e.g., a coating head, an extrusion die, etc.), a stranding arrangement 120, and a take-up reel 122. In some implementations, the manufacturing line 112 may include a curing station 118. In other implementations, the application station 116 also cures the bonding material. In certain implementations, the manufacturing line 112 may include an accumulator or other tensioning station 119 (e.g., a nip defined between driven rollers, a capstan, an accumulator, etc.) before the take-up reel 122. In certain examples, tension on the fibers 102 can be relieved or reduced at or after the tensioning structure 119 before the ribbon 100 is reeled on the take-up reel 122. In such cases, the ribbon 100 can be arranged in a rolled configuration at the time the ribbon 100 is reeled onto the take-up reel 122.

Each optical fiber 102 is paid out from a respective one of the reels 114 (e.g. by the tensioning station 119). The fibers 102 are routed from the reels 114 towards the application station 116. At the application station 116, the fibers 102 are arranged in a planar formation and the bonding material 104 is applied. In some implementations, the optical fibers 102 are then routed to an oven, a source of radiant energy such as a UV light emitter, or other curing station 118 to cure the dispensed bonding material 104. In other implementations, the application station 116 also is configured to cure the dispensed adhesive 104.

In accordance with some aspects of the disclosure, bonding material 104 may be applied and cured at the same station 116. In certain implementations, the bonding material application station 116 includes a first bonding material application station 116A for applying and optionally curing bonding material 104 at the first side 106 of the fibers 102 and a second bonding material application station 116B for applying and optionally curing bonding material 104 at the second side 108 of the fibers 102. In other implementations, bonding material 104 can be applied to both sides 106, 108 of the fibers 102 at the same station 116.

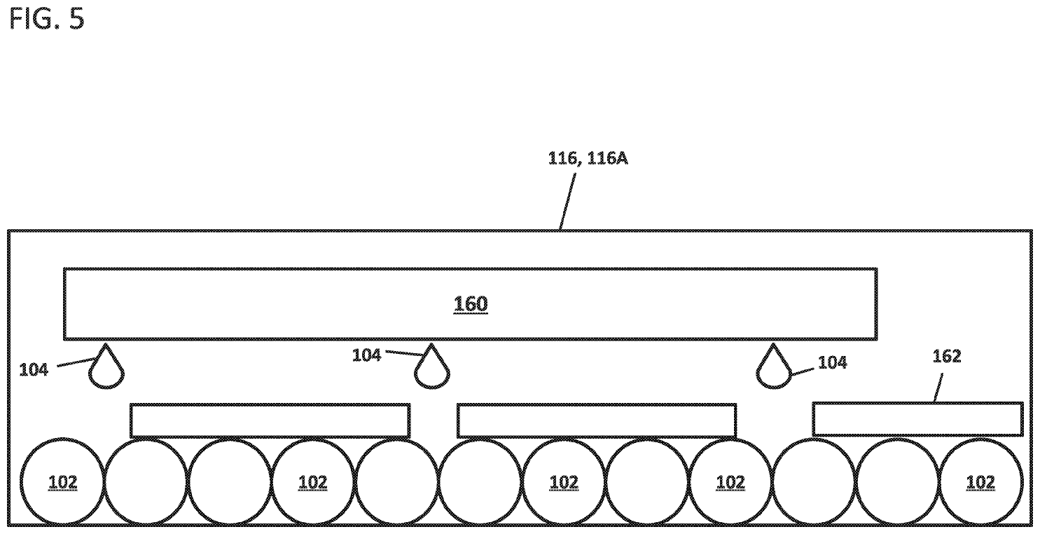

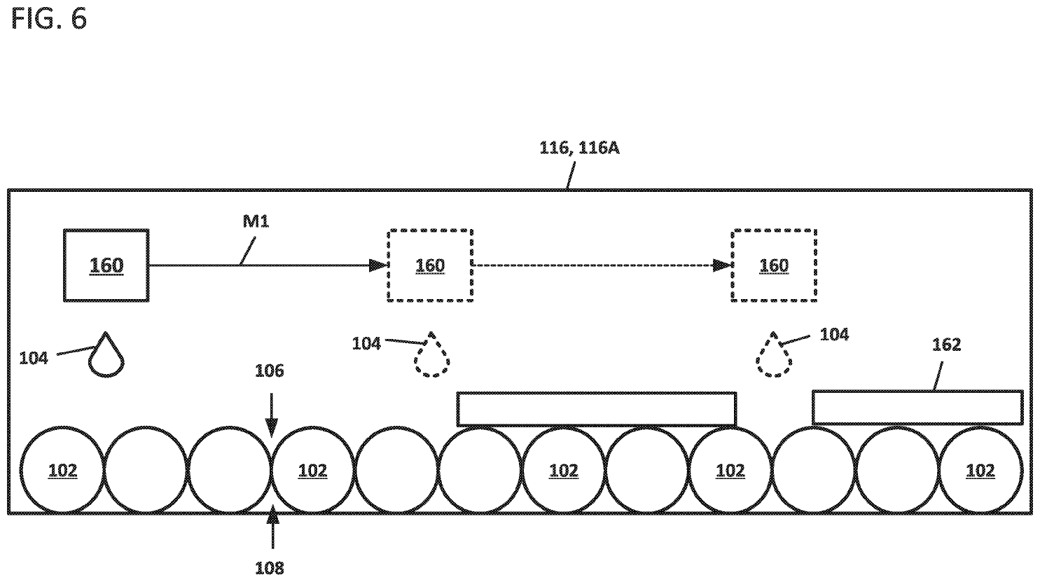

FIGS. 5 and 6 illustrate example implementations of an application station 116 suitable for use in dispensing bonding material 104 onto the optical fibers 102. The application station 116 includes a fixture 162 for positioning the optical fibers 102 in a planar configuration. In certain examples, the fixture 162 may include rollers to tension the fibers 102 to maintain the fibers 102 in position. In certain examples, the fixture 162 may include a flat die along which the fibers 102 pass. Other configurations are possible. For example, the fixture 162 may be disposed outside (e.g., upstream or downstream) of the application station 116.

The application station 116 also includes a dispenser 160 (e.g., a dot-matrix printer head, an inkjet style printer head, a needle-type dispenser, etc.) from which the bonding material 104 can be dispensed. In some implementations, the dispenser 160 is configured to dispense bonding material at multiple positions (e.g., from multiple nozzles or needles) along the width W (e.g., see FIG. 5). In other implementations, the dispenser 160 is configured to move along the width W to position a dispensing nozzle at contiguous edges of a select adjacent pair of fibers (e.g., see FIG. 6). In some implementations, the dispenser 160 can apply bonding material 104 from multiple positions along the width W and can move along the width W of the fibers 102. In certain implementations, the dispenser 160 can move along the length L to dispense a longer bead of bonding material 104. In other implementations, the fibers 102 pass through multiple rows of stationary dispensers 160. In still other implementations, the same dispenser 160 can vary the location along the width W from which bonding material 104 is dispensed. For example, the dispenser 160 may have multiple nozzles, but less than all of the nozzles dispense bonding material 104 simultaneously.

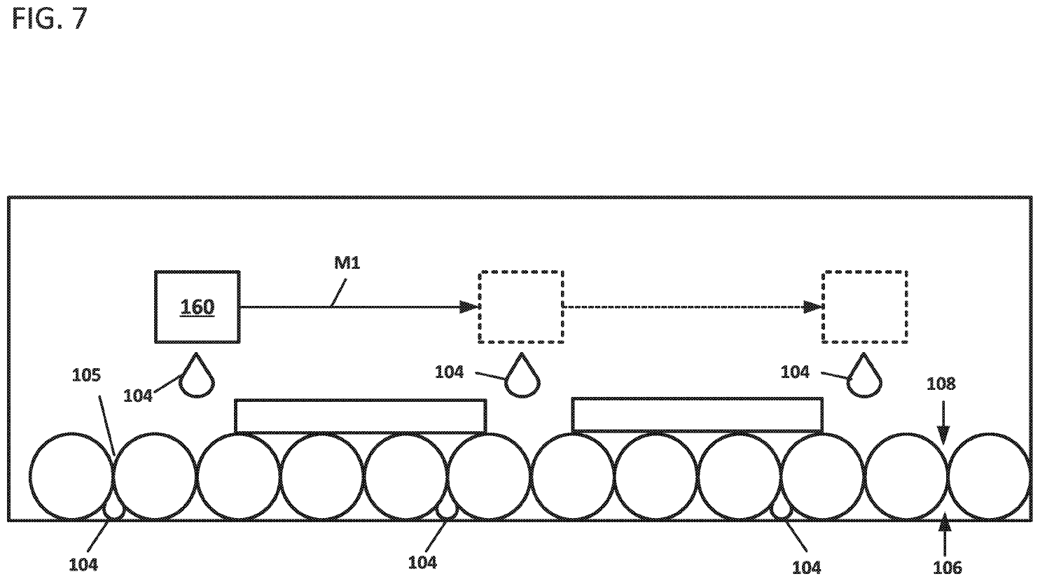

In some implementations, the optical fibers 102 can be routed between two oppositely facing dispensers 160 so that bonding material can be applied to both sides 106, 108 of the fibers 102 at the same station 116. In other implementations, the application stations 116 shown in FIGS. 5 and 6 are first application stations 116A and the fibers 102 can then be passed through a second application station 116B as shown in FIG. 7. In some examples, the second application station 116B has an opposite orientation to the first application station 110A. In other examples, the first and second application stations 116A, 116B have a common orientation and the optical fibers 102 are reoriented (e.g., flipped over) between the two stations 116A, 116B.

Referring back to FIG. 4, in some implementations, the bonding material 104 is cured before the fiber ribbon 100 is stranded. A stranding arrangement 120 twists the fiber ribbon 100 to form a helical configuration along the length of the fiber ribbon 100. In some implementations, the stranding arrangement 120 includes a stranding station to which the fiber ribbon 100 is routed after the bonding material 104 is cured. In other implementations, the stranding arrangement 120 includes a series of stranding dies or stations through which the fiber ribbon 100 passes to twist the fiber ribbon 100.

In certain implementations, one or more components of the manufacturing systems can be mounted to a water trough.

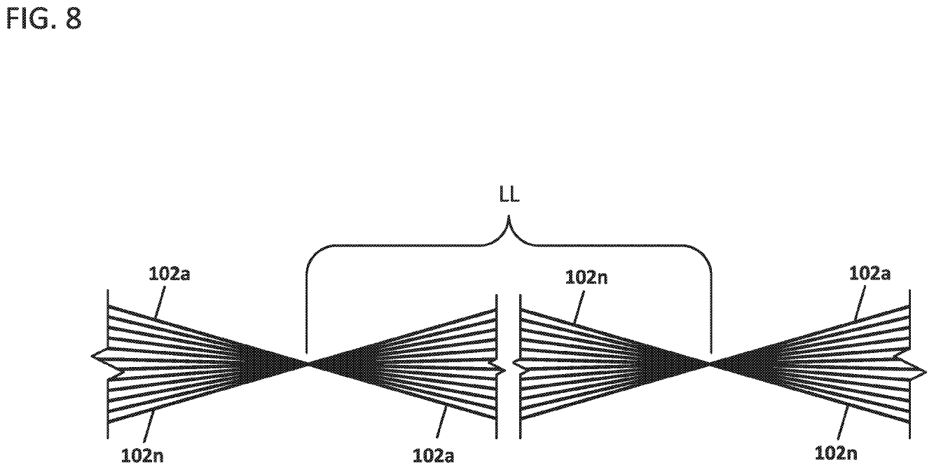

As shown in FIG. 8, the fiber ribbon 100 is stranded or helically twisted along a laylength LL. In the example shown, the fiber ribbon 100 includes a sequence of optical fibers 102 arranged consecutively from a first optical fiber 102a in the sequence to a last optical fiber 102n in the sequence. During the twisting or stranding process, the fiber ribbon 100 maintains the sequential relationship of the fibers 102.

In certain implementations, one or more of the fiber ribbons 100 may be disposed within a cable 170. For example, one or more of the rolled fiber ribbons 110 may be disposed within a jacket 172 of the cable 170. In certain implementations, the one or more fiber ribbons 100 may be stranded together with one or more cable components. In an example, the one or more fiber ribbons 100 may be wrapped around a cable component. For example, the one or more fiber ribbons 100 may be wrapped around a strength member 174 (e.g., a glass reinforced polymer (GRP) rod), a colored thread, or other such component. In another example, the cable component may be twisted around the one or more fiber ribbons 100. For example, a water blocking tape, a colored thread, strength members (e.g., aramid yarn) may be wrapped around the one or more fiber ribbons 100. In certain examples, two or more fiber ribbons 100 may be twisted together.

In certain implementations, a second fiber ribbon can be directed to the stranding arrangement 120 to be twisted with the fiber ribbon 100. Accordingly, multiple ribbon manufacturing lines 112 may share a common stranding arrangement 120 or portions of a stranding arrangement 120. In certain implementations, other cable components can be stranded with the fiber ribbon 100, such as one or more strength members, one or more ribbon indicators (e.g., colored threads), water blockers, electrical conductors, etc.). The stranded fiber ribbon 100 is wound onto a take-up reel 122.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. An optical fiber ribbon arrangement having oppositely-facing first and second major sides when arranged in a planar configuration, the optical fiber ribbon arrangement comprising:
a plurality of optical fibers disposed in a sequence;
a plurality of discrete volumes of bonding material intermittently disposed between adjacent pairs of the optical fibers along the first major side of the optical fiber ribbon arrangement; and
a plurality of discrete volumes of bonding material intermittently disposed between adjacent pairs of the optical fibers along the second major side of the optical fiber ribbon arrangement, the discrete volumes of bonding material at the second major side being offset from the discrete volumes of bonding material at the first major side.

2. The optical fiber ribbon arrangement of claim 1, wherein the bonding material is a UV curable resin.

3. The optical fiber ribbon arrangement of claim 1, wherein the discrete volumes of bonding material along the first and second major sides are disposed so that the optical fiber ribbon arrangement does not have a preferential bend.

4. The optical fiber ribbon arrangement of claim 1, wherein the bonding material is a thermally activated adhesive.

5. The optical fiber ribbon arrangement of claim 1, wherein the bonding material is a chemically activated adhesive.

6. The optical fiber ribbon arrangement of claim 1, wherein the discrete volumes of bonding material is disposed in a geometric pattern.

7. The optical fiber ribbon arrangement of claim 1, wherein the bonding material is disposed in V-shaped patterns.

8. The optical fiber ribbon arrangement of claim 1, wherein the discrete volumes of bonding material at the second major side are axially offset from the discrete volumes of bonding material at the first major side.

9. The optical fiber ribbon arrangement of claim 1, wherein the discrete volumes of bonding material at the second major side are laterally offset from the discrete volumes of bonding material at the first major side.

10. An optical fiber cable comprising:
a jacket defining an interior passage extending from a first axial end to a second axial end; and
at least one of the optical fiber ribbon arrangements as claimed in claim 1 disposed within the interior passage.

11. The optical fiber cable of claim 10, wherein the at least one of the optical fiber ribbon arrangements as claimed in claim 1 is one of a plurality of optical fiber ribbon arrangements as claimed in claim 1 disposed within the interior passage.

12. The optical fiber cable of claim 11, wherein the optical fiber ribbon arrangements are stranded together to form a cable core.

13. The optical fiber cable of claim 11, wherein the optical fiber ribbon arrangements are stranded with at least one strength layer.

14. The optical fiber cable of claim 10, wherein the at least one optical fiber ribbon arrangement as claimed in claim 1 is twisted along a lay length.

15. A method of manufacturing a fiber ribbon comprising:
arranging a plurality of optical fibers in a row having oppositely facing first and second major sides that extend along a length of the optical fibers;
intermittently applying bonding material in first discrete volumes along the first major side, each first discrete volume covering first portions of a respective adjacent pair of the optical fibers;
intermittently applying the bonding material in second discrete volumes along the second major side, each second discrete volume covering second portions of a respective adjacent pair of the optical fibers, the second portions being offset along the length of the optical fibers from the first portions.

16. The method of claim 15, wherein intermittently applying bonding material comprises applying bonding material using an intermittent spray application.

17. The method of claim 16, wherein intermittently applying bonding material comprises intermittently applying bonding material using a printer head.

18. The method of claim 15, further comprising curing the bonding material.

19. The method of claim 18, wherein the bonding material is cured using UV lights.

20. The method of claim 18, wherein the bonding material is cured using radiant heaters.

21. The method of claim 18, wherein the bonding material is cured using water spray.

22. The method of claim 15, wherein an even amount of the bonding material is applied to the first and second major sides of the row of optical fibers.
